(19) United States
(12) Patent Application Publication
(10) Pub. No.: US 2022/0417651 A1
(43) Pub. Date: Dec. 29, 2022

(54) PASSIVE RADIATOR UNIT AND SPEAKER SYSTEM COMPRISING SAME

(71) Applicant: AAC Microtech (Changzhou) Co., Ltd., Changzhou City (CN)

(72) Inventor: Juha Backman, Tampere (FI)

(21) Appl. No.: 17/356,539

(22) Filed: Jun. 24, 2021

(51) Int. Cl. H04R 1/28; H04R 1/02; H04R 7/14; H04R 7/20

(52) U.S. Cl. CPC H04R 1/2834; H04R 1/025; H04R 7/14; H04R 7/20

(57) ABSTRACT

A passive radiator unit and a speaker system using the passive radiator unit are provided. The passive radiator unit includes a first passive radiator comprising a first moving mass; a second passive radiator oriented opposite to the first passive radiator, the second passive radiator comprising a second moving mass; and a connecting structure connected between the first moving mass of the first passive radiator and the second moving mass of the second passive radiator. The connecting structure is configured to have a greater radial stiffness than an axial stiffness thereof to thereby prevent rocking movements while allowing normal vibrations of the first passive radiator and the second passive radiator in an axial direction of the passive radiator unit.

### FIELD OF THE INVENTION

The present disclosure relates to the field of speaker systems, and in particular, to a passive radiator unit and a speaker system comprising the passive radiator unit.

### BACKGROUND

Passive radiators are a well-known way of implementing the bass reflex principle in loudspeakers, and their important benefit is that they allow the bass reflex principle to be implemented in very small enclosures, where more conventional bass reflex loudspeakers with ports as radiating structures would be impossible to implement due to the port dimensions (either unrealistically narrow or unrealistically long). Recent experiments on mobile phone loudspeakers have demonstrated that the use of passive radiator technology is feasible, and does bring significant benefits in low frequency extent, distortion, and the available maximum sound pressure.

Although somewhat functional, the simple passive radiator enclosure consisting of a driver, cavity, and a single passive radiator with a mass and an outer edge suspension has some implementation related challenges. The first is that the volume displacement (surface area*displacement) of the passive radiator should preferably exceed that of the loudspeaker driver by a significant amount, and the second is that if the system is subject to an external mechanical shock (e.g. from dropping the device) it creates inside the cavity a pressure pulse that can damage the driver (this is a problem especially for portable devices). Also, as the moving mass of the passive radiator is typically larger than that of the driver, the vibration of the passive radiator causes at low frequencies even stronger reaction force on the device than in other loudspeaker types (ported reflex or sealed enclosures), although this could be used as an alert system.

These problems can be addressed by using two identical passive radiators symmetrically on both sides of the enclosure. This may solve the problems listed above: it is easy to increase the passive radiator area, the pressure pulses caused by the two radiators cancel each other if the device is dropped, and as in normal use the movement of two passive radiators is in the opposite directions, no net vibration force on the device housing is produced.

The symmetrical radiator structure does not, however, eliminate all the problems that arise when passive radiators are applied in very small form factor devices. The large moving mass, simple outer edge only support mechanism, and the inhomogeneous acoustical field inside and outside the radiator can easily give rise to rocking vibration in passive radiators, which in turn increases distortion, causes narrow-band irregularities in frequency response, and reduces the available maximum displacement. Strong rocking modes can also increase mechanical fatigue in the surround and thus reduce the lifetime of the device.

What is needed, therefore, is a mechanism capable of eliminating or suppressing the rocking vibration in passive radiators.

### SUMMARY

In one aspect, a passive radiator unit is provided which includes a first passive radiator comprising a first moving mass; a second passive radiator oriented opposite to the first passive radiator, the second passive radiator comprising a second moving mass; and a connecting structure connected between the first moving mass of the first passive radiator and the second moving mass of the second passive radiator. The connecting structure is configured to have a greater radial stiffness than an axial stiffness thereof to thereby prevent rocking movements while allowing normal vibrations of the first passive radiator and the second passive radiator in an axial direction of the passive radiator unit.

In another aspect, a speaker system is provided which includes an acoustic enclosure including a first wall and a second wall oriented opposite to each other, and a driver and a passive radiator unit mounted to the acoustic enclosure. The passive radiator unit includes a first passive radiator mounted to the first wall and including a first moving mass; a second passive radiator mounted to the second wall and aligned with the first passive radiator, the second passive radiator including a second moving mass; and a connecting structure connected between the first moving mass of the first passive radiator and the second moving mass of the second passive radiator. The connecting structure is configured to have a greater radial stiffness than an axial stiffness thereof to thereby prevent rocking movements while allowing normal vibrations of the first passive radiator and the second passive radiator in an axial direction of the passive radiator unit.

In some embodiments, the connecting structure includes a flexible member located between the first moving mass and the second moving mass; a first connecting member connecting the flexible member to the first moving mass; and a second connecting member connecting the flexible member to the second moving mass.

In some embodiments, the flexible member has a center and an outer edge, the first connecting member connects to the center of the flexible member, and the second connecting member connects to the outer edge of the flexible member.

In some embodiments, the first connecting member is one of a connecting rod or a connecting tube, and the second connecting member is a connecting ring.

In some embodiments, the connecting ring is perforated to prevent formation of an air spring between the flexible member and the second moving mass.

In some embodiments, the flexible member comprises one of a flexible plate having circumferential corrugations arranged in a radial direction from the center to the outer edge and a thin plate with cutouts defined between the center and the outer edge.

In some embodiments, the connecting structure further comprises a spring structure connecting the flexible member to fixed points outside an edge of the first and second passive radiators, the fixed points being configured to be fixed relative to an enclosure to which the passive radiator unit is to be mounted.

In some embodiments, the spring structure comprises a plurality of leaf springs.

In some embodiments, the flexible member has a center and an outer edge, the first connecting member connects to the center of the flexible member, the second connecting member connects to an area of the flexible member that is within the outer edge, and the outer edge extends to and is supported to fixed points which are configured to be fixed relative to an enclosure to which the passive radiator unit is to be mounted.

In some embodiments, the connecting structure includes a level mechanism ensuring parallel movement of the first passive radiator and the second passive radiator in the axial direction of passive radiator unit.

In some embodiments, the level mechanism includes at least one hinge-lever arrangement. Each hinge-lever arrangement includes a first lever part, a second lever part, and a rigid connecting lever. The first lever part includes a first rigid lever and a second rigid lever each having opposite two lever ends. One lever end of the first rigid lever is connected to the first moving mass through a first hinge, one lever end of the second rigid lever is connected to the second moving mass through a second hinge, and the other lever ends of the first rigid lever and the second rigid lever are connected together through a third hinge. The first hinge defines a first rotation axis perpendicular to the axial direction and is configured to permit rotation of the first rigid lever relative to the first moving mass only about the first rotation axis, the second hinge defines a second rotation axis perpendicular to the axial direction and is configured to permit rotation of the second rigid lever relative to the second moving mass only about the second rotation axis, and the third hinge defines a third rotation axis perpendicular to the axial direction and is configured to permit relative rotation of the first rigid lever and the second rigid lever only about the third rotation axis.

The second lever part includes a third rigid lever and a fourth rigid lever each having opposite two lever ends. One lever end of the third rigid lever is connected to the first moving mass through a fourth hinge, one lever end of the fourth rigid lever is connected to the second moving mass through a fifth hinge, and the other lever ends of the third rigid lever and the fourth rigid lever are connected together through a sixth hinge. The fourth hinge defines a fourth rotation axis perpendicular to the axial direction and is configured to permit rotation of the third rigid lever relative to the first moving mass only about the fourth rotation axis perpendicular to the axial direction, the fifth hinge defines a fifth rotation axis perpendicular to the axial direction and is configured to permit rotation of the fourth rigid lever relative to the second moving mass only about the fifth rotation axis, and the sixth hinge defines a sixth rotation axis perpendicular to the axial direction and is configured to permit relative rotation of the third rigid lever and the fourth rigid lever only about the sixth rotation axis. The first to sixth rotation axes are parallel to each other.

The rigid connecting lever has opposite two lever ends. One lever end of the connecting lever is connected to the third hinge such that the first, second and connecting levers are rotatable relative to each other about the third rotation axis, and the other lever end of the connecting lever is connected to the sixth hinge such that the third, fourth and connecting levers are rotatable relative to each other about the sixth rotation axis.

In some embodiments, the at least one hinge-lever arrangement includes a single hinge-lever arrangement, each of the first to sixth hinges extends over approximately full length of the first and second moving masses along its respective rotation axis.

In some embodiments, the at least one hinge-lever arrangement includes multiple hinge-lever arrangements disposed along an outer edge of the first and second moving masses.

Other aspects of the disclosure will become apparent by consideration of the detailed description and accompanying drawings.

### BRIEF DESCRIPTION OF THE DRAWINGS

FIG. 1 illustrates a speaker system in accordance with one embodiment of the present disclosure;

FIG. 2 is a side view of a passive radiator unit of the speaker system of FIG. 1 according to one embodiment;

FIG. 3 is a perspective view of the passive radiator unit of FIG. 2, with the first radiator removed;

FIG. 4 is a side view of a passive radiator unit of the speaker system of FIG. 1 according to another embodiment;

FIG. 5 is a perspective view of the passive radiator unit of FIG. 4, with the first radiator removed;

FIG. 6 is a side view of a passive radiator unit of the speaker system of FIG. 1 according to another embodiment;

FIG. 7 is a perspective view of the passive radiator unit of FIG. 6, with the first radiator removed;

FIG. 8 is a side view of a passive radiator unit of the speaker system of FIG. 1 according to another embodiment;

FIG. 9 is a perspective view of the passive radiator unit of FIG. 8, with the first radiator removed;

FIG. 10 is a side view of a passive radiator unit of the speaker system of FIG. 1 according to another embodiment;

FIG. 11 is a perspective view of the passive radiator unit of FIG. 10, with the first radiator removed;

FIG. 12 is a side view of a passive radiator unit of the speaker system of FIG. 1 according to still another embodiment; and

FIG. 13 is a perspective view of the passive radiator unit of FIG. 12, with the first radiator removed.

### DESCRIPTION OF THE EMBODIMENTS

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a passive radiator unit and a speaker system using the passive radiator unit. The passive radiator unit can include a connecting structure connecting two passive radiators in a manner that prevents harmful rocking movements while allowing normal vibrations of the radiator diaphragms.

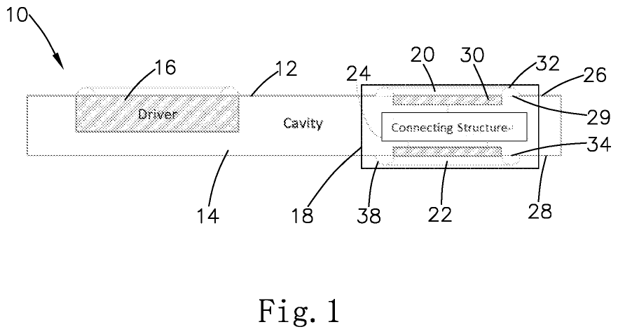

FIG. 1 illustrates a speaker system 10 in accordance with one embodiment of the present disclosure. The speaker system 10 generally includes an acoustic enclosure 12 defining an internal cavity 14 therein, and a driver 16 and a passive radiator unit 18 mounted to the enclosure 12. As well known in the art, the physical forward/back movement of the driver 16 affects the internal air pressure of the enclosure 12, and the internal air pressure fluctuations in turn cause the passive radiator unit 18 to begin vibrating in an axial direction of the passive radiator unit 18 to create sound frequencies. The speaker system 10 of this disclosure can be implemented as a standalone speaker. Alternatively, the speaker system 10 can also be embedded into a portable electronic device such as a mobile phone or a tablet PC.

The passive radiator unit 18 includes a first passive radiator 20, a second passive radiator 22 oriented opposite to the first passive radiator 20, and a connecting structure 24 interconnecting the first passive radiator 20 and the second passive radiator 22 to ensure that the first passive radiator 20 and the second passive radiator 22 move in parallel in the axial direction.

As illustrated, the enclosure 12 includes a first wall 26 and a second wall 28 oriented opposite to each other. The first wall 26 defines a first opening 29 to which the first passive radiator 20 is mounted. Specifically, the first passive radiator 20 includes a first moving mass 30 connected to an inner edge of a radiator diaphragm, and a first outer edge suspension 32 connected to an outer edge of the radiator diaphragm. The first outer edge suspension 32 is secured to an edge of the first opening 29. Similarly, the second wall 28 defines a second opening 34 to which the second passive radiator 22 is mounted. The first passive radiator 20 is aligned with the second passive radiator 22. The second passive radiator 22 includes a second moving mass 36 connected to an inner edge of a radiator diaphragm, and a second outer edge suspension 38 connected to an outer edge of the radiator diaphragm. The second outer edge suspension 38 is secured to an edge of the second opening 34. For the sake of clear illustration, the radiator diaphragms are not shown or can be considered part of the moving masses.

The connecting structure 24 is connected between the first moving mass 30 and the second moving mass 36. The connecting structure 24 has a very large radial stiffness and very low axial stiffness. In other words, the connecting structure 24 is rather stiff in the radial direction while compliant in the axial direction, thereby preventing undesired rocking movements while allowing normal vibrations of the first and second passive radiators 20, 22 in the axial direction. The term “normal vibrations” used in this disclosure refers to the vibrations of the radiators to create sound frequencies in response to the physical forward/back movement of the driver 16.

The connecting structure 24 can be implemented in many different ways, which is discussed below in connection with various embodiments of the passive radiator unit 18.

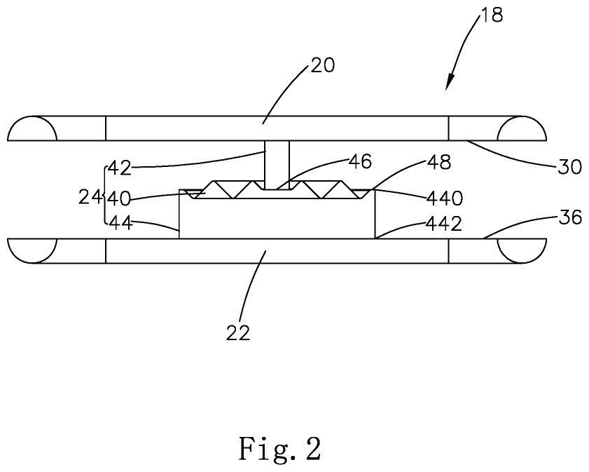

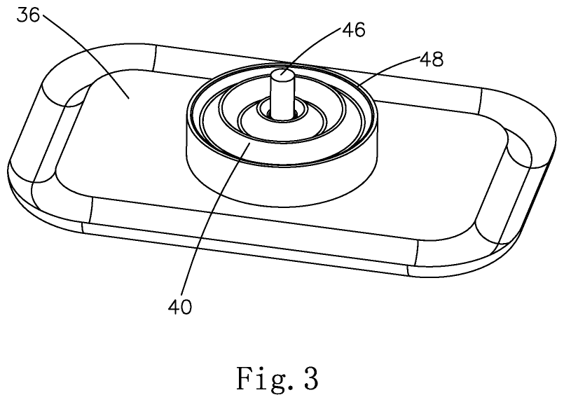

FIG. 2 and FIG. 3 illustrate a first embodiment of the passive radiator unit 18. As discussed above, the passive radiator unit 18 includes the first passive radiator 20, the second passive radiator 22 oriented opposite to the first passive radiator 20, and the connecting structure 24 interconnecting the first passive radiator 20 and the second passive radiator 22. In this embodiment, the connecting structure 24 includes a flexible member 40 located between the first moving mass 30 and the second moving mass 36, a first connecting member 42 connecting the flexible member 40 to the first moving mass 30, and a second connecting member 44 connecting the flexible member 40 to the second moving mass 36.

In the illustrated embodiment, the flexible member 40 is implemented as a flexible plate having a center 46 and an outer edge 48. The flexible plate gains flexibility by radial corrugations arranged from the center 46 to the outer edge 48. The first connecting member 42 connects to the center 46 of the corrugated flexible plate, and the second connecting member 44 connects to the outer edge 48 of the corrugated flexible plate.

The first connecting member 42 can be a connecting rod or a connecting tube. One end of the connecting rod or tube connects to the first moving mass 30, and the other end of the connecting rod or tube connects to the center 46 of the flexible plate. The second connecting member 44 can be a connecting ring supporting the outer edge 48 of the flexible plate. The connecting ring has opposite first and second ring sides 440, 442. The first ring side 440 connects to the outer edge 48 of the flexible plate, and the second ring side 442 connects to the second moving mass 36. The connecting ring may be perforated to prevent the formation of an air spring between the flexible plate and the second moving mass 36. Radial corrugations of the flexible plate make the flexible plate very compliant in the axial direction. The outer edge 48 of the flexible plate is connected to and hence supported by the connecting ring, which makes the flexible plate rather stiff in the radial direction. Due to the large stiffness of the flexible plate in the radial direction while low stiffness in the axial direction, the connecting structure 24 coupled between the first and second passive radiators 20, 22 is capable of preventing undesired rocking movements while allowing normal vibrations of the first and second passive radiators 20, 22 in the axial direction.

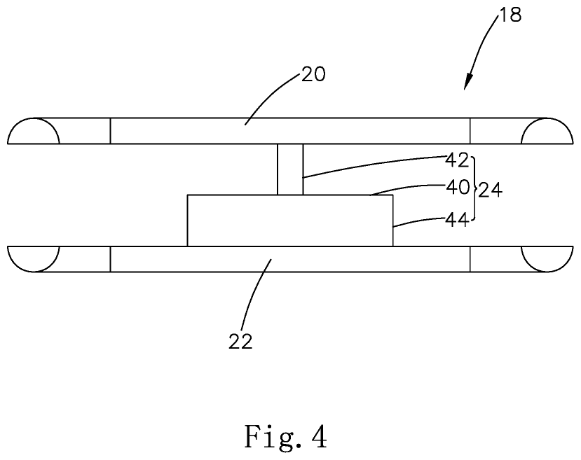

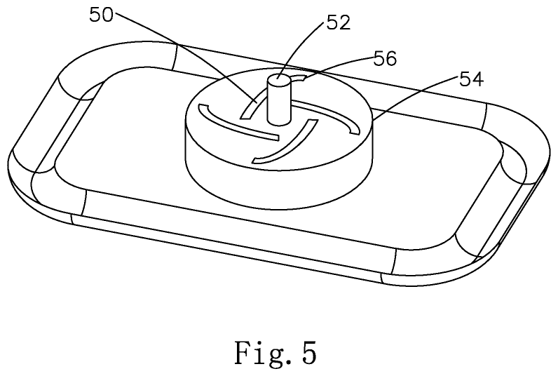

FIG. 4 and FIG. 5 illustrate a second embodiment of the passive radiator unit 18. The passive radiator unit 18 of the second embodiment is similar to the passive radiator unit 18 of the first embodiment, except for the flexible member 40. As illustrated in FIG. 4 and FIG. 5, the flexible member 40 of the passive radiator unit 18 of this embodiment is implemented as a thin plate with cutouts 50. The thin plate includes a center 52 and an outer edge 54. The cutouts 50 are defined and uniformly distributed between the center 52 and the outer edge 54. An outer end 56 of each cutout 50 is spaced a distance from the outer edge 54, so that the outer edge 54 remains a continuous structure. The purpose of the cutouts 50 is to make the thin plate very compliant in the axial direction. The outer edge 54 of the thin plate is connected to and hence supported by the connecting ring, which makes the thin plate stiff in the radial direction. Due to the large stiffness of the thin plate in the radial direction while low stiffness in the axial direction, the connecting structure 24 coupled between the first and second passive radiators 20, 22 is capable of preventing undesired rocking movements while allowing normal vibrations of the first and second passive radiators 20, 22 in the axial direction. The thin plate allows very thin structures of the passive radiator unit with minimal additional space between the radiators. To gain the large radial stiffness and low axial stiffness, the thin plate can have many different configurations, and the plate with cutouts is just a schematic illustration.

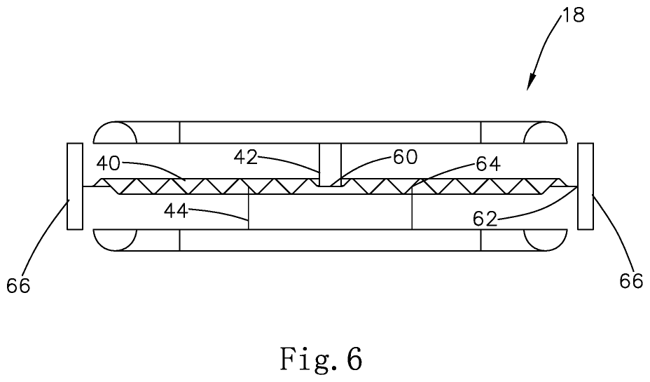

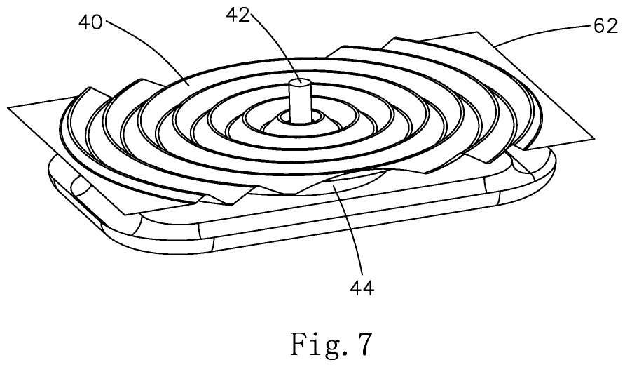

FIG. 6 and FIG. 7 illustrate a third embodiment of the passive radiator unit 18. The passive radiator unit 18 of the third embodiment is similar to the passive radiator unit 18 of the previous embodiments, except for the flexible member 40. As illustrated in FIG. 6 and FIG. 7, the flexible member 40 has a center 60 and an outer edge 62 and has circumferential corrugations arranged from the center 60 to the outer edge 62. The first connecting member 42 connects to the center 60 of the flexible member 40, and the second connecting member 44 connects to an area 64 of the flexible member 40 that is located within the outer edge 62 and spaced from the outer edge 62. The outer edge 62 extends to and is supported to fixed points 66 which are fixed relative to the acoustic enclosure. By supporting the central part of the flexible member 40 to the fixed points 66 outside the edge of the radiators, the stiffness of the connecting structure 24 against a torque on the center 60 is increased, which makes the connecting structure very effective against both antisymmetrical rocking modes and symmetrical rocking modes of the radiators. In the third embodiment, this is done by extending the corrugated flexible member 40 outside the edge of the radiator, thus creating something that resembles a common spider shared by the two passive radiators.

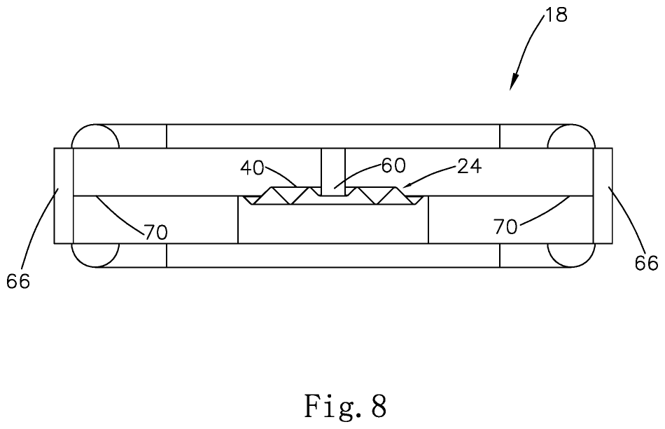

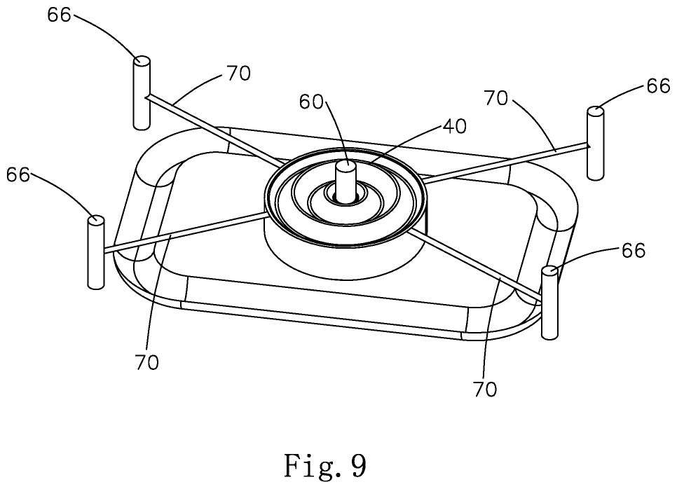

In a fourth embodiment illustrated in FIG. 8 and FIG. 9, the connecting structure 24 further includes a spring structure 70, such as leaf springs, connecting the flexible member 40 to fixed points 66 outside the edge of the radiators. As such, the central part of the flexible member 40 can be also supported to the exterior fixed points 66 and, therefore, the stiffness of the connecting structure 24 against a torque on the center 60 is also increased.

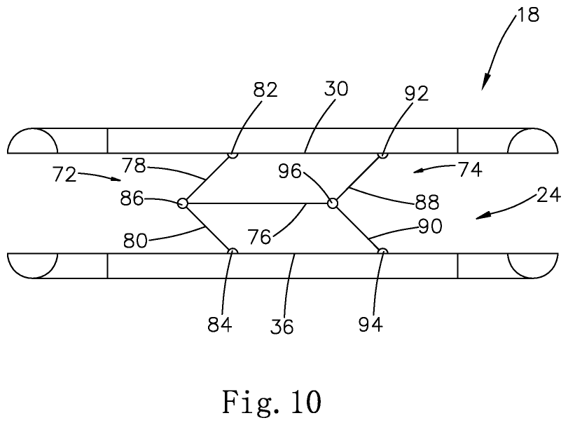

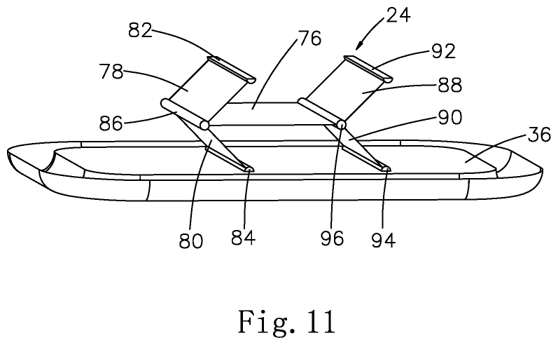

FIG. 10 and FIG. 11 illustrate a fifth embodiment of the passive radiator unit 18. The passive radiator unit 18 of the fifth embodiment is similar to the passive radiator unit of the previous embodiments, except for the connecting structure 24. The connecting structure 24 of the fifth embodiment includes a level mechanism ensuring parallel movement of the first passive radiator 20 and the second passive radiator 22 in the axial direction of passive radiator unit 18. The level mechanism includes at least one hinge-lever arrangement 240. FIG. 10 and FIG. 11 illustrate the embodiment having a single hinge-lever arrangement 240 which is a four-lever system. It should be understood, however, that other amounts of levers are also possible as long as the parallel movement of the first and second passive radiators 20, 22 can be achieved. In this particular embodiment, the hinge-lever arrangement 240 includes a first lever part 72, a second lever part 74, and a rigid connecting lever 76 interconnecting the first lever part 72 and the second lever part 74. The first lever part 72 includes a first rigid lever 78 and a second rigid lever 80 each having opposite two lever ends. One lever end of the first rigid lever 78 is connected to the first moving mass 30 through a first hinge 82, one lever end of the second rigid lever 80 is connected to the second moving mass 36 through a second hinge 84, and the other lever ends of the first rigid lever 78 and the second rigid lever 80 are connected together through a third hinge 86. The first hinge 82 defines a first rotation axis perpendicular to the axial direction, and is configured to permit rotation of the first rigid lever 78 relative to the first moving mass 30 only about the first rotation axis. The second hinge 84 defines a second rotation axis perpendicular to the axial direction, and is configured to permit rotation of the second rigid lever 80 relative to the second moving mass 36 only about the second rotation axis. The third hinge 86 defines a third rotation axis perpendicular to the axial direction, and is configured to permit relative rotation of the first rigid lever 78 and the second rigid lever 80 only about the third rotation axis.

The second lever part 74 includes a third rigid lever 88 and a fourth rigid lever 90 each having opposite two lever ends. One lever end of the third rigid lever 88 is connected to the first moving mass 30 through a fourth hinge 92, one lever end of the fourth rigid lever 90 is connected to the second moving mass 36 through a fifth hinge 94, and the other lever ends of the third rigid lever 88 and the fourth rigid lever 90 are connected together through a sixth hinge 96. The fourth hinge 92 defines a fourth rotation axis perpendicular to the axial direction, and is configured to permit rotation of the third rigid lever 88 relative to the first moving mass 30 only about the fourth rotation axis. The fifth hinge 94 defines a fifth rotation axis perpendicular to the axial direction, and is configured to permit rotation of the fourth rigid lever 90 relative to the second moving mass 36 only about the fifth rotation axis. The sixth hinge 96 defines a sixth rotation axis perpendicular to the axial direction, and is configured to permit relative rotation of the third rigid lever 88 and the fourth rigid lever 90 only about the sixth rotation axis. The first to sixth rotation axes are parallel to each other.

The rigid connecting lever 76 has opposite two lever ends. One lever end of the connecting lever 76 is connected to the third hinge 86 such that the first, second and connecting levers are rotatable relative to each other about the third rotation. The other lever end of the connecting lever 76 is connected to the sixth hinge 96 such that the third, fourth and connecting levers are rotatable relative to each other about the sixth rotation axis. With the rigid connecting lever 76 interconnected between the first lever part 72 and the second lever part 74, the first lever part 72 and the second lever part 74 move in synchronization with each other, thereby achieving parallel movement of the first passive radiator 20 and the second passive radiator 22 in the axial direction.

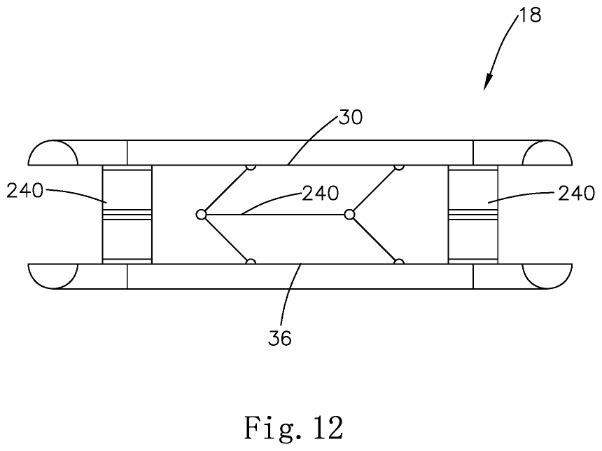

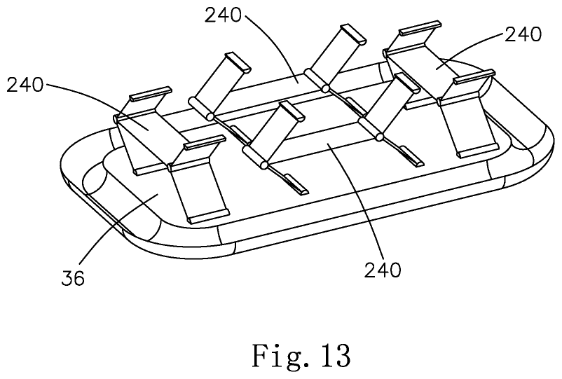

As illustrated in FIG. 10 and FIG. 11, the level mechanism includes only a single hinge-lever arrangement 240. In this case, each of the first to sixth hinges 82, 84, 86, 92, 94, 96 extends over approximately full length of the first and second moving masses 30, 36 along its respective rotation axis. In a sixth embodiment illustrated in FIG. 12 and FIG. 13, the level mechanism of the connecting structure 24 includes multiple hinge-lever arrangements 240, e.g. four hinge-lever arrangements disposed along an outer edge of the first and second moving masses 30, 36, and each hinge-lever arrangement 240 of FIG. 12 and FIG. 13 has the same construction (e.g. hinges, levers) as that of FIG. 10 and FIG. 11, except for the length of the hinges. In this case, each of the hinges of FIG. 12 and FIG. 13 has a shorter length than that of the hinges of FIG. 10 and FIG. 11. In some other embodiments not illustrated, the lever mechanism can include at least one hinge-lever arrangement as disclosed herein.

In summary, embodiments of the present disclosure provide a passive radiator unit and a speaker system using the passive radiator unit. The passive radiator unit includes a connecting structure connecting two passive radiators in a manner that prevents harmful rocking movements while allowing normal vibrations of the radiator diaphragms. The connecting structure can be implements in many different ways. For example, the connecting structure can include a flexible member located between the first moving mass and the second moving mass, a first connecting member connecting the flexible member to the first moving mass, and a second connecting member connecting the flexible member to the second moving mass. The flexible member can be a corrugated flexible plate or a thin plate with cutouts defined therein. A central part of the flexible member can further be supported to fixed points outside the edge of the radiators, which makes the connecting structure very effective against both antisymmetrical rocking modes and symmetrical rocking modes of the radiators. The connecting structure can also be a lever mechanism ensuring parallel movement of the first passive radiator and the second passive radiator in the axial direction of passive radiator unit.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A passive radiator unit comprising:
a first passive radiator comprising a first moving mass;
a second passive radiator oriented opposite to the first passive radiator, the second passive radiator comprising a second moving mass; and
a connecting structure connected between the first moving mass of the first passive radiator and the second moving mass of the second passive radiator, the connecting structure configured to have a greater radial stiffness than an axial stiffness thereof to thereby prevent rocking movements while allowing normal vibrations of the first passive radiator and the second passive radiator in an axial direction of the passive radiator unit.

2. The passive radiator unit of claim 1, wherein the connecting structure includes:
a flexible member located between the first moving mass and the second moving mass;
a first connecting member connecting the flexible member to the first moving mass; and
a second connecting member connecting the flexible member to the second moving mass.

3. The passive radiator unit of claim 2, wherein the flexible member has a center and an outer edge, the first connecting member connects to the center of the flexible member, and the second connecting member connects to the outer edge of the flexible member.

4. The passive radiator unit of claim 3, wherein the first connecting member is one of a connecting rod or a connecting tube, and the second connecting member is a connecting ring.

5. The passive radiator unit of claim 4, wherein the connecting ring is perforated to prevent formation of an air spring between the flexible member and the second moving mass.

6. The passive radiator unit of claim 3, wherein the flexible member comprises one of a flexible plate having circumferential corrugations arranged in a radial direction from the center to the outer edge and a thin plate with cutouts defined between the center and the outer edge.

7. The passive radiator unit of claim 3, wherein the connecting structure further comprises a spring structure connecting the flexible member to fixed points outside an edge of the first and second passive radiators, the fixed points being configured to be fixed relative to an enclosure to which the passive radiator unit is to be mounted.

8. The passive radiator unit of claim 7, wherein the spring structure comprises a plurality of leaf springs.

9. The passive radiator unit of claim 2, wherein the flexible member has a center and an outer edge, the first connecting member connects to the center of the flexible member, the second connecting member connects to an area of the flexible member that is within the outer edge, and the outer edge extends to and is supported to fixed points which are configured to be fixed relative to an enclosure to which the passive radiator unit is to be mounted.

10. The passive radiator unit of claim 1, wherein the connecting structure includes a level mechanism ensuring parallel movement of the first passive radiator and the second passive radiator in the axial direction of passive radiator unit.

11. The passive radiator unit of claim 10, wherein the level mechanism includes at least one hinge-lever arrangement, each hinge-lever arrangement includes:
a first lever part including a first rigid lever and a second rigid lever each having opposite two lever ends, one lever end of the first rigid lever connected to the first moving mass through a first hinge, one lever end of the second rigid lever connected to the second moving mass through a second hinge, the other lever ends of the first rigid lever and the second rigid lever connected together through a third hinge, wherein the first hinge defines a first rotation axis perpendicular to the axial direction and is configured to permit rotation of the first rigid lever relative to the first moving mass only about the first rotation axis, the second hinge defines a second rotation axis perpendicular to the axial direction and is configured to permit rotation of the second rigid lever relative to the second moving mass only about the second rotation axis, and the third hinge defines a third rotation axis perpendicular to the axial direction and is configured to permit relative rotation of the first rigid lever and the second rigid lever only about the third rotation axis;
a second lever part including a third rigid lever and a fourth rigid lever each having opposite two lever ends, one lever end of the third rigid lever connected to the first moving mass through a fourth hinge, one lever end of the fourth rigid lever connected to the second moving mass through a fifth hinge, the other lever ends of the third rigid lever and the fourth rigid lever connected together through a sixth hinge, wherein the fourth hinge defines a fourth rotation axis perpendicular to the axial direction and is configured to permit rotation of the third rigid lever relative to the first moving mass only about the fourth rotation axis perpendicular to the axial direction, the fifth hinge defines a fifth rotation axis perpendicular to the axial direction and is configured to permit rotation of the fourth rigid lever relative to the second moving mass only about the fifth rotation axis, the sixth hinge defines a sixth rotation axis perpendicular to the axial direction and is configured to permit relative rotation of the third rigid lever and the fourth rigid lever only about the sixth rotation axis, and the first to sixth rotation axes are parallel to each other; and
a rigid connecting lever having opposite two lever ends, one lever end of the connecting lever connected to the third hinge such that the first, second and connecting levers are rotatable relative to each other about the third rotation axis, and the other lever end of the connecting lever connected to the sixth hinge such that the third, fourth and connecting levers are rotatable relative to each other about the sixth rotation axis.

12. The passive radiator unit of claim 11, wherein the at least one hinge-lever arrangement includes a single hinge-lever arrangement, each of the first to sixth hinges extends over approximately full length of the first and second moving masses along its respective rotation axis.

13. The passive radiator unit of claim 11, wherein the at least one hinge-lever arrangement includes multiple hinge-lever arrangements disposed along an outer edge of the first and second moving masses.

14. A speaker system comprising:
an acoustic enclosure including a first wall and a second wall oriented opposite to each other; and
a driver and a passive radiator unit mounted to the acoustic enclosure, the passive radiator unit including:
a first passive radiator mounted to the first wall and including a first moving mass;
a second passive radiator mounted to the second wall and aligned with the first passive radiator, the second passive radiator including a second moving mass; and
a connecting structure connected between the first moving mass of the first passive radiator and the second moving mass of the second passive radiator, the connecting structure configured to have a greater radial stiffness than an axial stiffness thereof to thereby prevent rocking movements while allowing normal vibrations of the first passive radiator and the second passive radiator in an axial direction of the passive radiator unit.

15. The speaker system of claim 14, wherein the connecting structure includes:
a flexible member located between the first moving mass and the second moving mass;
a first connecting member connecting the flexible member to the first moving mass; and
a second connecting member connecting the flexible member to the second moving mass.

16. The passive radiator unit of claim 15, wherein the flexible member comprises a flexible plate having a center and an outer edge, the flexible plate having circumferential corrugations arranged in a radial direction from the center to the outer edge, the first connecting member connects to the center of the flexible plate, and the second connecting member connects to the outer edge of the flexible plate.

17. The passive radiator unit of claim 16, wherein the first connecting member is one of a connecting rod or a connecting tube, and the second connecting member is a connecting ring, the connecting ring being perforated to prevent formation of an air spring between the flexible member and the second moving mass.

18. The passive radiator unit of claim 16, wherein the connecting structure further comprises a spring structure connecting the flexible member to fixed points that are located outside an edge of the first and second passive radiators and fixed relative to the acoustic enclosure.

19. The passive radiator unit of claim 15, wherein the flexible member has a center and an outer edge, the first connecting member connects to the center of the flexible member, the second connecting member connects to an area of the flexible member that is located within and spaced from the outer edge, and the outer edge extends to and is supported to fixed points which are fixed relative to the acoustic enclosure.

20. The passive radiator unit of claim 14, wherein the connecting structure includes a level mechanism ensuring parallel movement of the first passive radiator and the second passive radiator in the axial direction of passive radiator unit, the level mechanism includes at least one hinge-lever arrangement, each hinge-lever arrangement includes:
a first lever part including a first rigid lever and a second rigid lever each having opposite two lever ends, one lever end of the first rigid lever connected to the first moving mass through a first hinge, one lever end of the second rigid lever connected to the second moving mass through a second hinge, the other lever ends of the first rigid lever and the second rigid lever connected together through a third hinge, wherein the first hinge defines a first rotation axis perpendicular to the axial direction and is configured to permit rotation of the first rigid lever relative to the first moving mass only about the first rotation axis, the second hinge defines a second rotation axis perpendicular to the axial direction and is configured to permit rotation of the second rigid lever relative to the second moving mass only about the second rotation axis, and the third hinge defines a third rotation axis perpendicular to the axial direction and is configured to permit relative rotation of the first rigid lever and the second rigid lever only about the third rotation axis;
a second lever part including a third rigid lever and a fourth rigid lever each having opposite two lever ends, one lever end of the third rigid lever connected to the first moving mass through a fourth hinge, one lever end of the fourth rigid lever connected to the second moving mass through a fifth hinge, the other lever ends of the third rigid lever and the fourth rigid lever connected together through a sixth hinge, wherein the fourth hinge defines a fourth rotation axis perpendicular to the axial direction and is configured to permit rotation of the third rigid lever relative to the first moving mass only about the fourth rotation axis perpendicular to the axial direction, the fifth hinge defines a fifth rotation axis perpendicular to the axial direction and is configured to permit rotation of the fourth rigid lever relative to the second moving mass only about the fifth rotation axis, the sixth hinge defines a sixth rotation axis perpendicular to the axial direction and is configured to permit relative rotation of the third rigid lever and the fourth rigid lever only about the sixth rotation axis, and the first to sixth rotation axes are parallel to each other; and
a rigid connecting lever having opposite two lever ends, one lever end of the connecting lever connected to the third hinge such that the first, second and connecting levers are rotatable relative to each other about the third rotation axis, and the other lever end of the connecting lever connected to the sixth hinge such that the third, fourth and connecting levers are rotatable relative to each other about the sixth rotation axis.
